(19) United States
(12) Patent Application Publication
(10) Pub. No.: US 2026/0203788 A1
(43) Pub. Date: Jul. 16, 2026

(54) PLANOGRAM-LOCKED VOICE-TO-TAG TELEMETRY FOR REAL-TIME PRODUCT INSIGHTS

(71) Applicant: IEVGENIIA SHNEIDER, DELTONA, FL (US)

(72) Inventor: IEVGENIIA SHNEIDER, DELTONA, FL (US)

(21) Appl. No.: 19/562,766

(22) Filed: Mar. 11, 2026

(30) Foreign Application Priority Data
Feb. 13, 2026 (US) 63/982817

(51) Int. Cl. G06Q 30/0242; G09F 3/20

(52) U.S. Cl. CPC G06Q 30/0242; G09F 3/208

(57) ABSTRACT

A privacy-preserving, edge-computing telemetry system and method for generating real-time product insights at a physical shelf location. A shelf-edge device is provisioned with a planogram snapshot identifier that constrains a local acoustic classification model to a specific semantic taxonomy relevant to proximate products. Upon detecting localized acoustic events, the device buffers acoustic samples exclusively into an ephemeral volatile memory. The device extracts features and infers semantic event tokens from the buffered samples without generating verbatim textual transcripts. Immediately upon classification, the device zeroizes the volatile memory buffer to physically preclude the retention of raw audio data, ensuring zero-retention privacy. The inferred semantic event tokens are locally aggregated into discrete time buckets. To prevent individual re-identification, the device transmits a telemetry payload to a remote server only if the aggregated count for a specific token satisfies a predefined k-threshold release policy during the time interval.

### CROSS-REFERENCE TO RELATED APPLICATIONS

This application claims the benefit of priority under 35 U.S.C. § 119(e) to U.S. Provisional Patent Application No. 63/982,817, filed on 2026 Feb. 13, the entire disclosure of which is hereby incorporated by reference in its entirety for all purposes.

### STATEMENT REGARDING FEDERALLY SPONSORED RESEARCH OR DEVELOPMENT

Not applicable.

### BACKGROUND OF THE INVENTION

### Field of the Invention

The present disclosure generally relates to the field of retail analytics, Internet of Things (IoT) systems, and edge computing. More specifically, the present disclosure relates to privacy-preserving acoustic telemetry, edge-based signal processing, and hardware-constrained systems configured to generate non-reconstructable semantic insights from localized in-store interactions without retaining, transmitting, or persistently storing raw audio, conversational transcripts, or personally identifiable information (PII).

### Description of Related Art

In the highly competitive retail and fast-moving consumer goods (FMCG) industries, brands and manufacturers continuously seek actionable, real-time feedback regarding consumer reactions to specific products at the point of consideration (e.g., in front of a branded shelf display). Conventional approaches to gathering consumer insights primarily rely on delayed, lagging indicators such as point-of-sale (POS) transaction data, product return rates, online reviews, and periodic focus groups or surveys. These traditional signals suffer from significant latency, inherent selection bias, and a lack of specific, in-the-moment shelf-level context.

To address the need for in-store analytics, various technological solutions have been proposed and deployed in the prior art. However, these conventional systems suffer from severe technical, operational, and legal deficiencies. For example, some conventional systems employ computer vision, video surveillance, or gaze-tracking technologies to monitor consumer engagement. While these systems can measure dwell time or physical interactions, they are inherently invasive. They capture biometric data (e.g., facial features) and raise severe privacy and regulatory compliance concerns under frameworks such as the General Data Protection Regulation (GDPR) and the California Consumer Privacy Act (CCPA). Furthermore, vision-based systems can only infer that an interaction occurred; they cannot capture the semantic reason or qualitative perception (e.g., “this smells too sweet” or “the texture is too heavy”) underlying a consumer's decision to reject a product.

Other conventional systems utilize physical “smart shelves” equipped with weight sensors, pressure mats, or Radio Frequency Identification (RFID) tags. These inventory-centric systems are strictly limited to tracking product movement or planogram compliance. They merely detect that an item was removed from or returned to a shelf, providing absolutely no qualitative, semantic, or emotional feedback regarding the consumer's perception of the product itself.

In an attempt to capture qualitative feedback, some conventional approaches deploy microphones to record in-store audio, which is then continuously streamed to remote cloud servers for Speech-to-Text (STT) transcription and Natural Language Processing (NLP). This cloud-dependent architecture introduces critical vulnerabilities. First and foremost, transmitting or storing raw audio streams and verbatim transcripts exposes sensitive consumer conversations to interception and misuse, posing unacceptable privacy, legal, and reputational risks. Second, continuously streaming high-fidelity audio from thousands of shelf-edge devices consumes excessive network bandwidth and incurs prohibitive cloud computing and data ingress costs, rendering the system economically unscalable. Finally, reliance on continuous cloud connectivity introduces high latency and renders the system fragile in typical retail environments, which frequently suffer from unreliable wireless network coverage.

Accordingly, there remains an unmet need in the art for a highly localized, scalable, and privacy-by-architecture telemetry system capable of extracting semantic meaning directly at the edge (e.g., at the retail shelf). There is a specific need for a hardware and software architecture that inherently prevents the retention or transmission of raw media and transcripts, drastically reduces bandwidth and cloud processing costs, and securely delivers aggregated, threshold-gated insights tied to specific physical product placements without compromising consumer privacy.

### SUMMARY OF THE INVENTION

The present disclosure overcomes the aforementioned technical and operational drawbacks of conventional retail analytics systems by providing a privacy-by-architecture system, method, and edge-computing apparatus for generating planogram-bound, non-reconstructable semantic event tokens (referred to herein as “tags”) from localized acoustic signals. Advantageously, the disclosed system operates strictly at the shelf edge to extract real-time consumer preference insights without recording, transmitting, or persistently storing raw audio files, conversational transcripts, or personally identifiable information (PII).

According to one aspect of the present disclosure, a method for generating privacy-preserving product insights comprises provisioning a shelf-edge device with a planogram snapshot identifier. The planogram snapshot identifier binds the shelf-edge device to a specific physical shelf segment and dynamically dictates the selection of a constrained taxonomy subset and a corresponding localized acoustic classification model. By strictly limiting the active lexicon to terms relevant only to the proximate products (e.g., locking a device to a “fragrance” taxonomy rather than a general-purpose language model), the system drastically reduces cross-brand attribution errors, minimizes on-device computational overhead, and mitigates the need for continuous cloud connectivity.

According to another aspect of the present disclosure, the shelf-edge device executes a strictly ephemeral processing pipeline to ensure zero-retention of sensitive media. The device continuously or intermittently monitors for speech-like activity using an event gating mechanism. Upon triggering, the device captures a short sequence of acoustic samples exclusively into an ephemeral, volatile memory buffer (e.g., volatile RAM). The device locally extracts compact acoustic features and classifies the features against the planogram-bound constrained taxonomy to generate one or more semantic tags (e.g., a token indicating “sweetness-negative” or “freshness-positive”). Crucially, immediately upon classification or expiration of a timeout period, the ephemeral memory buffer is overwritten or zeroized. The device physically and programmatically prevents the storage of raw audio in non-volatile memory and entirely bypasses the generation of verbatim textual transcripts.

In yet another aspect of the present disclosure, to further eliminate the risk of individual re-identification and to radically reduce network bandwidth consumption, the system employs a localized k-threshold aggregation mechanism. Rather than transmitting individual semantic tags as they occur, the shelf-edge device locally accumulates tag counts within discrete time intervals (time buckets) and applies deduplication rules to prevent overcounting from isolated bursts. The device transmits a telemetry payload to a remote analytics service only if the aggregated count for at least one tag meets or exceeds a predefined minimum threshold k (the “k-threshold release policy”). If the threshold is not met, the sparse data is treated as statistical noise and discarded or withheld.

According to further aspects of the present disclosure, a remote analytics service ingests the thresholded aggregate payloads from a plurality of shelf-edge devices via a secure network interface. The remote service enforces strict multi-tenant data isolation, ensuring that product brands access only aggregate metrics corresponding to their assigned planogram configurations. The analytics service processes these leading indicators to generate real-time dashboards, anomaly alerts, and trend visualizations, thereby enabling rapid supply chain and merchandising optimizations based on empirical, shelf-level consumer sentiment, all while maintaining absolute cryptographic and architectural privacy.

### BRIEF DESCRIPTION OF THE DRAWINGS

FIG. 1 is a schematic overview of the shelf-edge telemetry system architecture, illustrating the secure, unidirectional data flow from one or more shelf-edge devices over a network to a remote cloud service for ingestion, aggregation, and dashboard generation.

FIG. 2 is a block diagram illustrating the hardware and software computing modules of a shelf-edge device, including an acoustic sensor, an event gating mechanism, a feature extraction module, a constrained taxonomy tag classifier, a local aggregation module, a k-threshold release policy controller, and a secure transmitter.

FIG. 3 is a flow diagram illustrating the strictly ephemeral on-device processing pipeline, demonstrating the conversion of localized acoustic signals into semantic tags without retaining persistent raw audio or generating textual transcripts.

FIG. 4 is a logical diagram illustrating the planogram snapshot binding mechanism, wherein a planogram version identifier hardware-constrains the taxonomy subset and dictates model/lexicon selection to reduce computational overhead and eliminate cross-brand ambiguity.

FIG. 5 is a schematic diagram illustrating the privacy-by-architecture memory handling protocol, highlighting the exclusive capture of acoustic data into volatile RAM for inference, followed by immediate and irreversible zeroization of the buffer to physically preclude raw audio storage in non-volatile memory.

FIG. 6 is a flow diagram illustrating the thresholded aggregate privacy scheme, detailing the accumulation of semantic tags into discrete time buckets, deduplication mechanisms, the application of a k-threshold release rule, and the optional introduction of bounded noise to prevent individual re-identification.

FIG. 7 is a block diagram illustrating the cloud data ingestion and analytics pipeline, detailing the processes of packet ingestion, schema validation, strict tenant isolation at the brand level, aggregate data storage, and insight engine execution.

FIG. 8 illustrates exemplary analytics outputs and dashboard user interfaces generated from the thresholded aggregates, including ranked top negative drivers, trend changes over time and region, automated anomaly alerts, and before/after experiment comparisons.

FIG. 9 is a flow diagram illustrating the secure over-the-air (OTA) update process, comprising cryptographic signature verification of update packages, staged rollout of planogram-bound lexicons and models, and secure rollback mechanisms.

FIG. 10 is a topological diagram illustrating a multi-brand deployment within a single retail location, demonstrating the strict binding of devices to specific shelf segments (e.g., Brand A, Brand B, Brand C) and the logical data partitioning that ensures aggregate insights are securely isolated and accessible exclusively to authorized brand tenants.

### DETAILED DESCRIPTION OF THE INVENTION

The following detailed description refers to the accompanying drawings. Wherever possible, the same reference numbers are used in the drawings and the following description to refer to the same or similar elements. While preferred embodiments of the invention are described, modifications, adaptations, and other implementations are possible without departing from the spirit and scope of the invention.

### System Architecture Overview

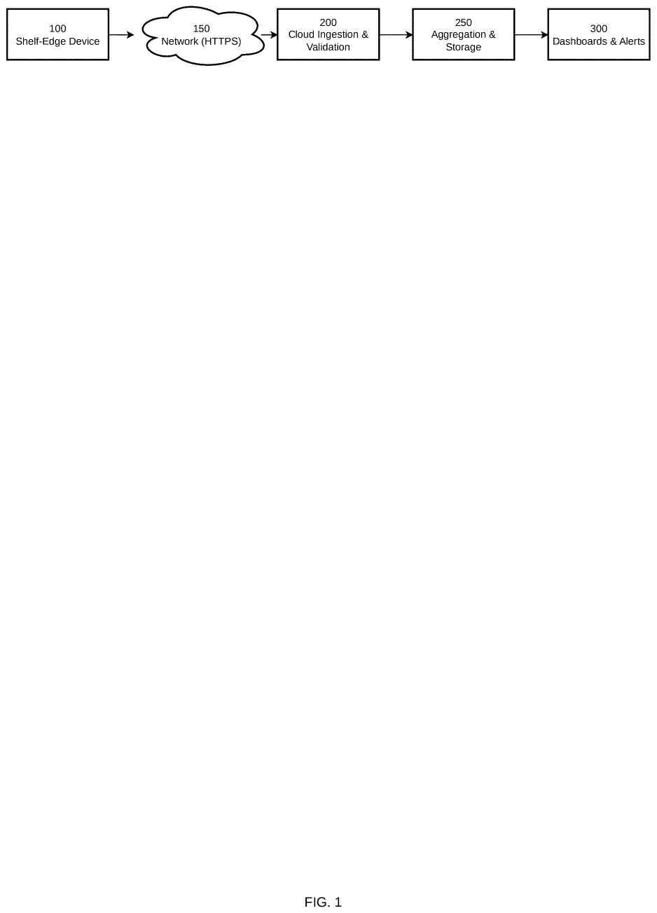

Referring now to FIG. 1, a schematic overview of the shelf-edge telemetry system architecture is illustrated. The system comprises a plurality of shelf-edge devices deployed across one or more retail locations. Each shelf-edge device is physically and logically assigned to a specific shelf segment identifier and is provisioned with a corresponding planogram snapshot version. The architecture ensures a secure, unidirectional flow of telemetry data from the shelf-edge devices over a network to a remote analytics service.

A critical technical advantage of the disclosed architecture is that the primary privacy boundary is established directly at the edge. The shelf-edge devices locally infer tag events from acoustic signals and accumulate counts per tag in time buckets. The remote analytics service receives only thresholded aggregates, storing metrics under strict tenant isolation and presenting analytical dashboards via a user interface.

### Hardware Configuration and Volatile Memory Management

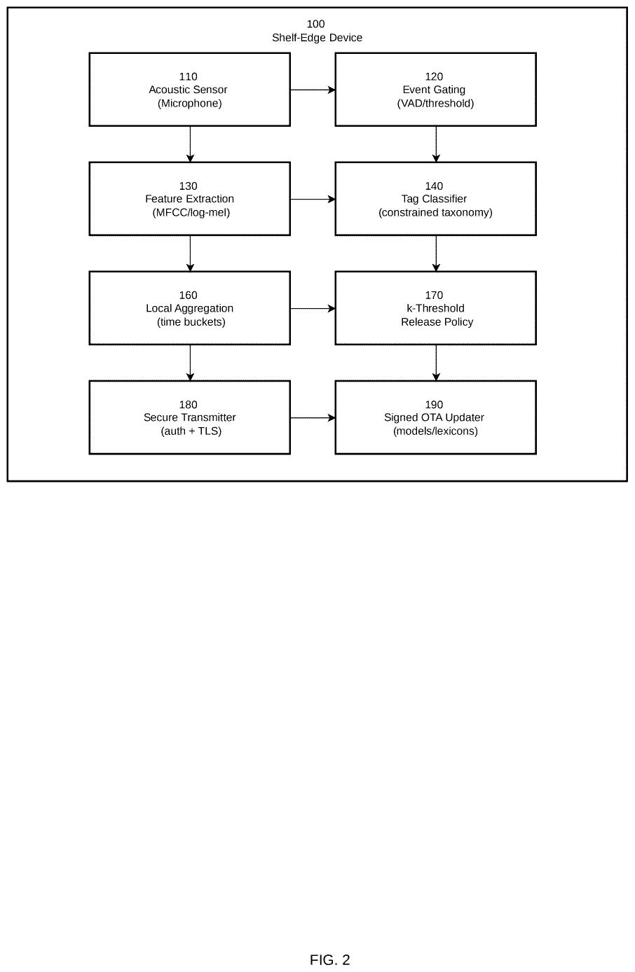

As illustrated in FIG. 2, the hardware configuration of the shelf-edge device is specifically optimized for edge computing under stringent power, memory, and privacy constraints. In a preferred embodiment, the shelf-edge device includes an acoustic sensor (e.g., a microphone), a compute module (such as a microcontroller or edge processor), volatile memory for ephemeral buffering and inference, non-volatile memory for firmware and the tag model/lexicon, a secure network interface, and a power subsystem.

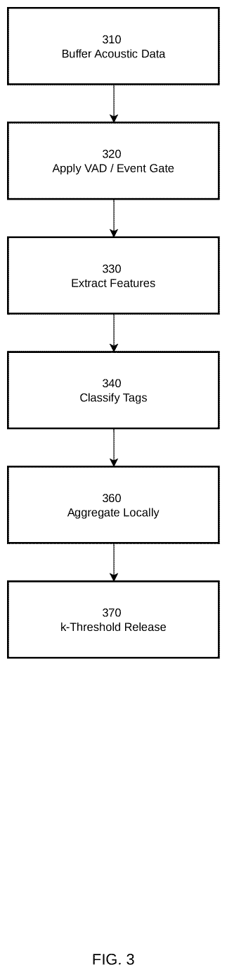

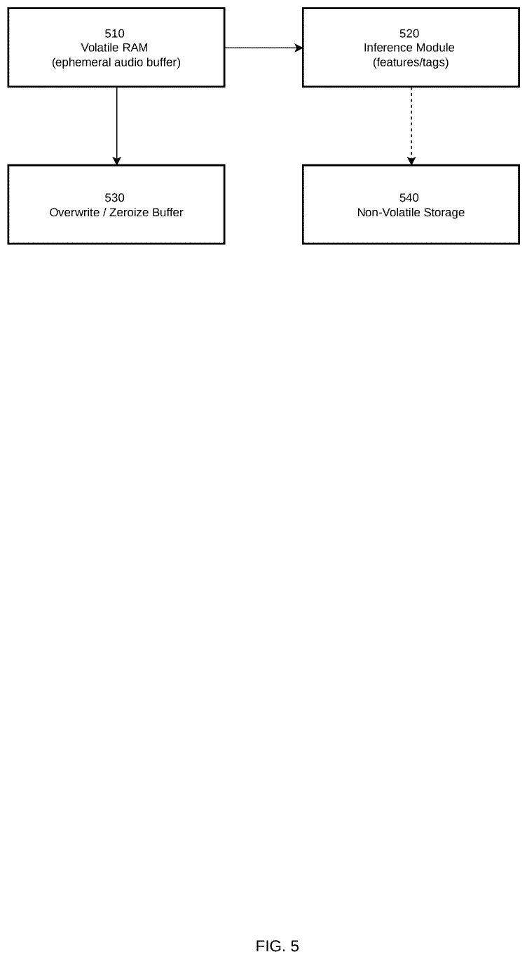

The fundamental privacy-by-architecture mechanism, defined herein as “Zero-Retention,” is further detailed in FIG. 3 and FIG. 5. The device is hardware-configured such that raw audio samples are not stored persistently and are held only in volatile memory for the short durations required for inference. Upon completion of the classification task, or upon expiration of a predefined timeout, the device immediately executes an overwrite or zeroize operation on the audio buffer. Consequently, raw audio is never written to non-volatile storage, and the device neither produces nor stores verbatim transcripts of speech. This renders the semantic event tokens completely non-reconstructable into the original acoustic signal.

### Event Gating and On-Device Feature Extraction

To operate efficiently in high-noise retail environments, the shelf-edge device continuously or intermittently monitors for speech-like activity using an event gating mechanism, such as Voice Activity Detection (VAD) or an equivalent acoustic threshold trigger. Upon detecting speech-like activity, the device buffers a short segment of audio samples into the ephemeral volatile memory buffer for a highly limited duration (e.g., 0.25 to 2.0 seconds).

This ephemeral buffer is used solely for local feature extraction and classification. The compute module processes the raw audio signal to extract compact acoustic features, such as log-mel spectrograms or Mel-frequency cepstral coefficients (MFCC). In some embodiments, feature computation is performed over overlapping frames to significantly improve system robustness and accuracy against ambient store noise.

### Planogram-Locked Constrained Taxonomy

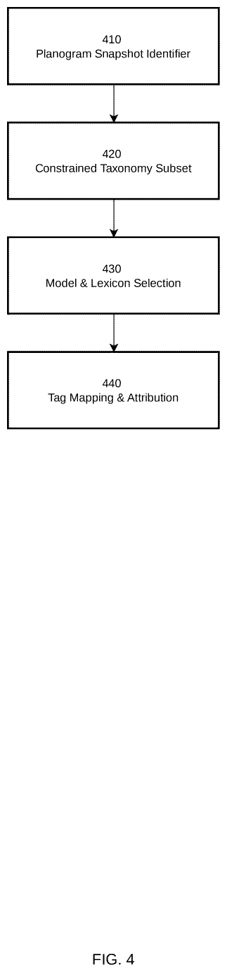

Referring to FIG. 4, the present invention utilizes a planogram snapshot binding mechanism to drastically reduce computational overhead and cross-brand ambiguity. Each shelf-edge device is bound to a planogram snapshot described by a planogram version identifier and an associated constrained taxonomy subset.

The planogram snapshot defines the active product families or SKUs for the specific shelf segment and explicitly dictates the permissible tag taxonomy subset relevant to those products. Consequently, the device selects or is provisioned with a highly specialized acoustic model and lexicon keyed precisely to the planogram snapshot. By constraining the classification space to shelf-relevant terms (e.g., restricting the lexicon to fragrance-related semantic tokens like SWEETNESS or FRESHNESS), the system minimizes the misattribution of tags to adjacent shelves and obviates the need for resource-intensive, general-purpose Large Language Models (LLMs).

### Edge Machine Learning and Semantic Classification

Following feature extraction, a trained tag classifier on the device maps the extracted features to one or more tag IDs selected exclusively from the constrained taxonomy. The tag classifier comprises a lightweight neural network (e.g., a TinyML model) optimized for edge execution via techniques such as INT8 weight quantization.

The output of the classifier is a structured semantic representation comprising a tag ID, a polarity indicator or score (e.g., positive, negative, neutral), and a confidence score. Crucially, the system extracts the semantic intent or perception underlying the consumer's reaction without relying on Speech-to-Text (STT) conversion, thereby completely avoiding the generation or retention of any textual transcript.

### k-threshold Release Policy and Privacy Engine

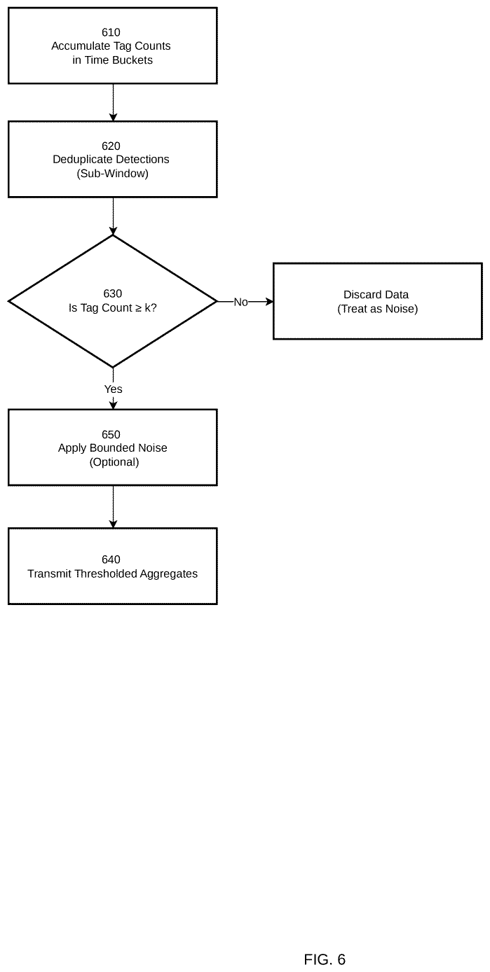

To absolutely eliminate the risk of individual re-identification, the system employs a proprietary thresholded aggregate privacy scheme, as illustrated in FIG. 6. Rather than transmitting each tag instantaneously, the device locally accumulates counts per tag across discrete time buckets (e.g., 5, 10, 15, or 60 minute intervals).

During accumulation, the device applies deduplication rules to avoid overcounting repeated detections originating from the same local burst within a short sub-window. At the conclusion of the time bucket, a k-threshold release policy is strictly enforced: the device transmits the aggregated counts to the remote server only if at least one tag's count reaches a predefined minimum threshold k within the bucket. Data failing to meet this threshold is discarded as statistical noise, thereby preventing the transmission of sparse, potentially sensitive single events. In further embodiments, the device or cloud service may apply bounded mathematical noise to the counts to further reduce linkage risk while preserving macro-level trends.

### Cloud Ingestion, Tenant Isolation, and OTA Updates

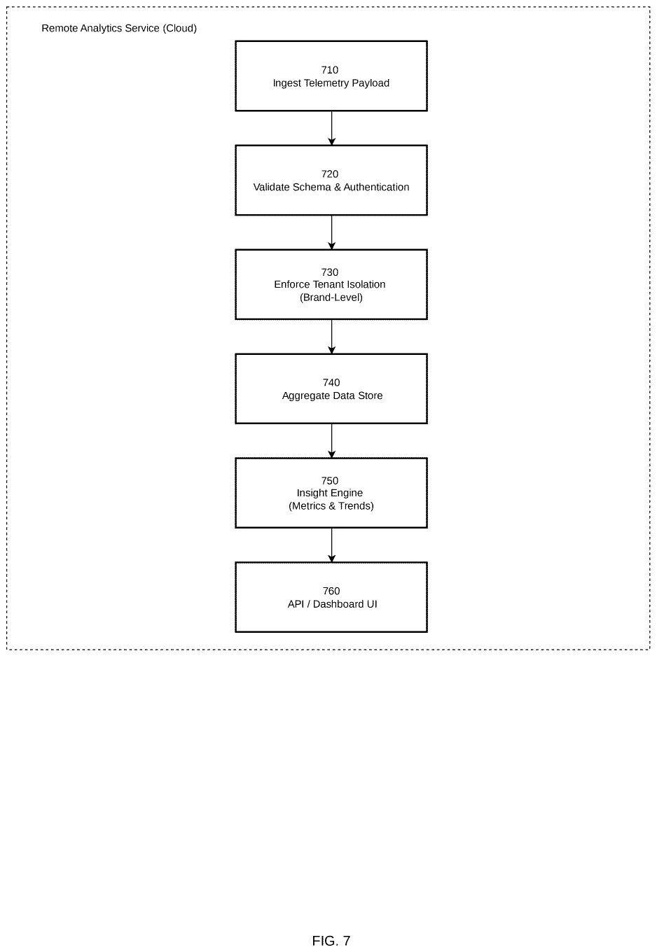

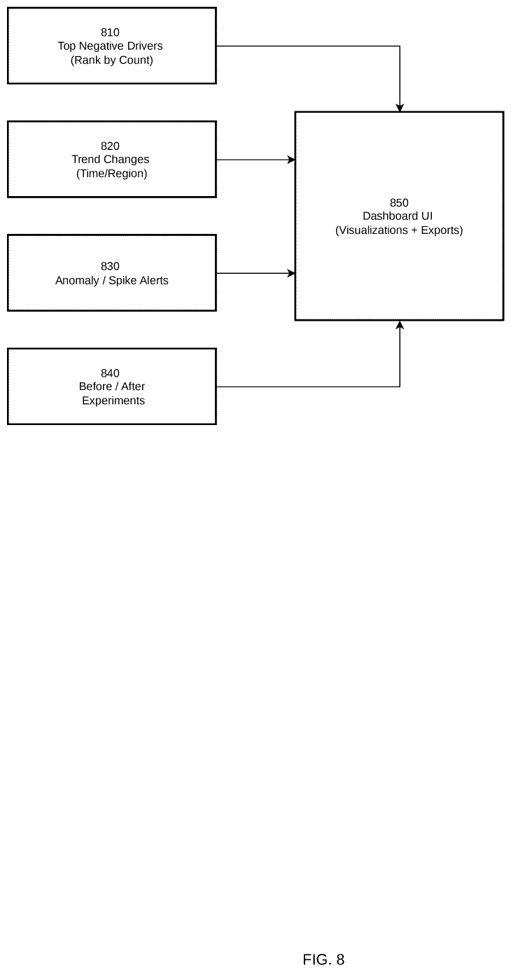

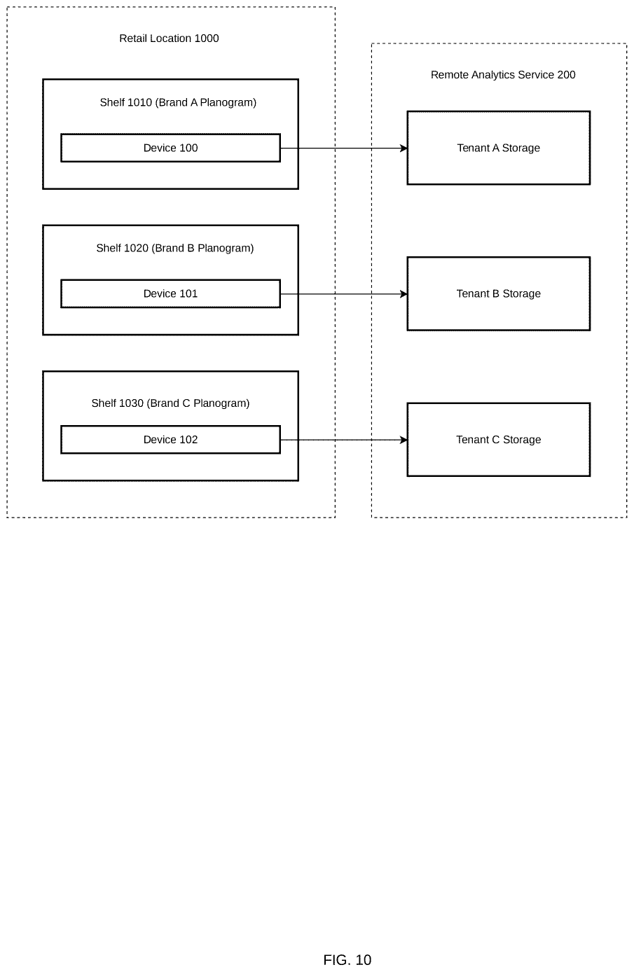

Referring to FIG. 7 and FIG. 10, the remote analytics service ingests the thresholded aggregates, authenticates the devices, and enforces strict tenant isolation. This brand-level data partitioning ensures that users representing specific brands access only the aggregate metrics derived from their respective assigned shelf segments. As shown in FIG. 8, the cloud insight engine computes actionable metrics such as top negative trait drivers, anomaly alerts, and before/after merchandising experiment comparisons and presents them via real-time dashboard visualizations.

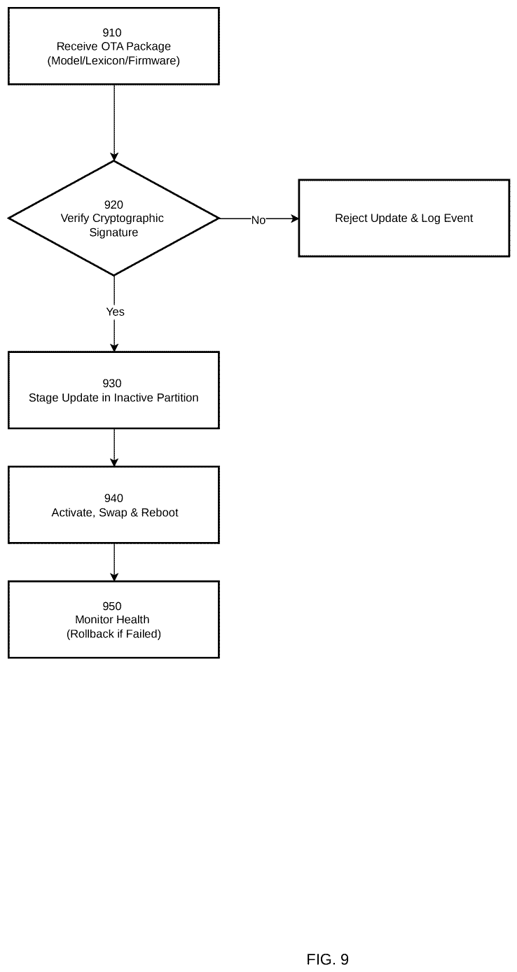

To maintain optimal model performance and taxonomy relevance without physical intervention, the system includes a secure over-the-air (OTA) update module, detailed in FIG. 9. The device supports cryptographically signed updates for firmware and planogram-bound lexicons/models, wherein the device verifies the signature prior to activation. The system supports staged rollouts and secure rollback procedures, while audit logs meticulously record the specific model and lexicon versions executing on each device per time window, ensuring continuous compliance and audibility.

What is claimed is:

1. A method for generating privacy-preserving, planogram-bound product insights at a physical shelf location, the method comprising: provisioning a shelf-edge device with a planogram snapshot identifier associated with the physical shelf location, wherein the planogram snapshot identifier defines a constrained taxonomy subset relevant to products positioned at the physical shelf location; buffering acoustic samples into an ephemeral volatile memory buffer of the shelf-edge device upon detecting a localized acoustic event; extracting acoustic features from the buffered acoustic samples and locally classifying the acoustic features into at least one semantic tag selected from the constrained taxonomy subset, without generating a textual transcript of the acoustic samples; immediately zeroizing the ephemeral volatile memory buffer after the classifying step such that raw audio data is not retained in a non-volatile memory; locally aggregating counts of the at least one semantic tag within a predefined time interval; and transmitting a thresholded aggregate payload to a remote server only when an aggregated count for a specific semantic tag meets or exceeds a predefined minimum threshold k during the predefined time interval.

2. The method of claim 1, wherein classifying the acoustic features into the at least one semantic tag comprises outputting a semantic event token including a tag identifier, a polarity indicator, and a confidence score.

3. The method of claim 1, further comprising deduplicating repeated detections of the same semantic tag within a localized sub-window of the predefined time interval prior to the aggregating step to prevent overcounting.

4. The method of claim 1, further comprising dynamically selecting an acoustic classification model and a corresponding lexicon on the shelf-edge device based strictly on the provisioned planogram snapshot identifier.

5. The method of claim 1, further comprising discarding the locally aggregated counts without transmission to the remote server when the predefined minimum threshold k is not met during the predefined time interval.

6. The method of claim 1, further comprising applying a bounded mathematical noise to the locally aggregated counts prior to transmitting the thresholded aggregate payload to further obscure individual event linkages.

7. The method of claim 1, further comprising receiving, by the remote server, the thresholded aggregate payload and enforcing a strict tenant isolation policy such that the thresholded aggregate payload is accessible exclusively to a brand tenant associated with the planogram snapshot identifier.

8. The method of claim 1, further comprising receiving, at the shelf-edge device, a cryptographically signed over-the-air (OTA) update comprising an updated planogram-bound lexicon, and verifying a cryptographic signature of the OTA update prior to activation.

9. A privacy-preserving shelf-edge apparatus for generating real-time product insights, the apparatus comprising: an acoustic sensor; a volatile memory buffer configured for ephemeral data storage; a non-volatile memory storing a constrained taxonomy subset and a classification model associated with a specific planogram snapshot identifier; a secure network interface; and a compute module communicatively coupled to the acoustic sensor, the volatile memory buffer, the non-volatile memory, and the secure network interface, the compute module configured to: capture acoustic samples via the acoustic sensor into the volatile memory buffer upon detecting an acoustic event; extract features from the acoustic samples and execute the classification model to infer at least one semantic tag from the constrained taxonomy subset, without producing a textual transcript; overwrite the volatile memory buffer immediately subsequent to inferring the at least one semantic tag to physically prevent retention of raw audio data; accumulate instances of the inferred at least one semantic tag into time-bucketed counts; and transmit a thresholded telemetry payload via the secure network interface only if a count for the at least one semantic tag satisfies a k-threshold release policy defining a minimum required occurrence threshold k.

10. The apparatus of claim 9, wherein the compute module is further configured to trigger the capture of the acoustic samples based on a voice activity detection (VAD) gating signal.

11. The apparatus of claim 9, wherein the semantic tag comprises a non-reconstructable token representing a qualitative consumer preference relevant to a product defined by the planogram snapshot identifier.

12. The apparatus of claim 9, wherein the compute module is configured to execute the classification model utilizing INT8 weight quantization optimized for edge processing.

13. The apparatus of claim 9, wherein the apparatus does not transmit per-event timestamps associated with individual acoustic events, transmitting only the thresholded telemetry payload representing an aggregate interval.

14. The apparatus of claim 9, wherein the compute module is further configured to process the acoustic samples via overlapping frames to extract the features, the features comprising Mel-frequency cepstral coefficients (MFCC) or log-mel representations.

15. A non-transitory computer-readable storage medium storing instructions that, when executed by an edge processor of a shelf-edge device, cause the shelf-edge device to perform operations comprising: receiving a planogram snapshot identifier that defines a permissible semantic tag taxonomy subset relevant to a specific retail shelf segment; buffering localized acoustic data exclusively into an ephemeral volatile memory array; inferring a semantic event token from the buffered localized acoustic data using a local machine learning model constrained by the permissible semantic tag taxonomy subset; zeroizing the ephemeral volatile memory array immediately upon inference to preclude persistent audio storage and transcription; aggregating the inferred semantic event token into a temporal bucket; and initiating a secure transmission of an aggregated count of the semantic event token to a remote server only upon determining that the aggregated count equals or exceeds a k-anonymity threshold value k within the temporal bucket.
